(19) United States
(12) Patent Application Publication
(10) Pub. No.: US 2025/0379208 A1
(43) Pub. Date: Dec. 11, 2025

(54) ANNEALED AND PRELITHIATED ALUMINUM ANODE ACTIVE MATERIAL LAYER WITH HIGH GRAIN BOUNDARY DISTRIBUTION

(71) Applicant: GM GLOBAL TECHNOLOGY OPERATIONS LLC, Detroit, MI (US)

(72) Inventors: Zhe LI, Shanghai (CN); Henry ZHAN, Shanghai (CN); Qili SU, Shanghai (CN); Haijing LIU, Shanghai (CN); Congjie WANG, Shanghai (CN)

(21) Appl. No.: 18/760,281

(22) Filed: Jul. 1, 2024

(30) Foreign Application Priority Data
Jun. 7, 2024 (CN) 2024107409427

(51) Int. Cl. H01M 4/04; B21B 3/00; B32B 15/01; C22F 1/04; C22F 1/16

(52) U.S. Cl. CPC H01M 4/0445; B21B 3/00; C22F 1/04; C22F 1/16; H01M 4/0435; H01M 4/0471; B21B 2003/001; B32B 15/013; B32B 2457/10

(57) ABSTRACT

A method for manufacturing an anode electrode includes rolling a first aluminum foil layer; annealing the first aluminum foil layer to create a first annealed aluminum foil layer; mechanically bonding a first lithium metal foil layer between an anode current collector and the first annealed aluminum foil layer; and aging the anode electrode to prelithiate the first annealed aluminum foil layer.

### CROSS-REFERENCE TO RELATED APPLICATIONS

This application claims the benefit of Chinese Patent Application No. 202410740942.7 filed on Jun. 7, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode active material layers of anode electrodes of battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing an anode electrode includes rolling a first aluminum foil layer; annealing the first aluminum foil layer to create a first annealed aluminum foil layer; mechanically bonding a first lithium metal foil layer between an anode current collector and the first annealed aluminum foil layer; and aging the anode electrode to prelithiate the first annealed aluminum foil layer.

In other features, a thickness of the first annealed aluminum foil layer is in a range from 2 μm to 80 μm. A thickness of the first annealed aluminum foil layer is in a range from 30 μm to 50 μm. The first annealed aluminum foil layer comprise aluminum in a range from 94.0 to 99.99 wt %. The annealing of the first annealed aluminum foil layer is performed at a temperature in a range from 250° C. to 550° C.

In other features, an annealing period of the first annealed aluminum foil layer is in a range from 10 minutes to 24 hours. A grain boundary distribution (>15°) of the first annealed aluminum foil layer after annealing is in a range from 46% to 80%. A prelithiation period is in a range from 1 minute to 14 days.

In other features, prior to the mechanically bonding, the method includes arranging a second lithium metal foil layer adjacent to an opposite side of the anode current collector and a second annealed aluminum foil layer adjacent to the second lithium metal foil layer. The mechanically bonding further comprises mechanically bonding the first annealed aluminum foil layer, the first lithium metal foil layer, the anode current collector, the second lithium metal foil layer, and the second annealed aluminum foil layer. The aging further includes aging the anode electrode to prelithiate the second annealed aluminum foil layer.

A method for manufacturing an anode electrode includes rolling an aluminum foil layer; annealing the aluminum foil layer to form an annealed aluminum foil layer; mechanically bonding a separator layer and the annealed aluminum foil layer to opposite sides of a lithium metal foil layer; and aging the anode electrode to prelithiate the annealed aluminum foil layer.

In other features, the separator layer comprises a polymer layer. A thickness of the annealed aluminum foil layer is in a range from 2 μm to 80 μm. A thickness of the annealed aluminum foil layer is in a range from 30 μm to 50 μm. The annealed aluminum foil layer comprise aluminum in a range from 94.0 to 99.99 wt %. The annealing of the annealed aluminum foil layer is performed at a temperature in a range from 250° C. to 550° C.

In other features, an annealing period of the annealed aluminum foil layer is in a range from 10 minutes to 24 hours. A grain boundary distribution (>15°) of the annealed aluminum foil layer is in a range from 46% to 80%.

A method for manufacturing an anode electrode includes rolling an aluminum foil layer; annealing the aluminum foil layer to form an annealed aluminum foil layer; mechanically bonding a first lithium metal foil layer and a second lithium metal foil layer to opposite sides of the annealed aluminum foil layer; and aging the anode electrode to prelithiate the annealed aluminum foil layer.

In other features, annealing of the annealed aluminum foil layer is performed at a temperature in a range from 250° C. to 550° C. An annealing period of the annealed aluminum foil layer is in a range from 10 minutes to 24 hours.

In other features, a thickness of the annealed aluminum foil layer is in a range from 2 μm to 80 μm, the annealed aluminum foil layer comprises aluminum in a range from 94.0 to 99.99 wt %, and a grain boundary distribution (>15°) of the annealed aluminum foil layer is in a range from 46% to 80%.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell according to the present disclosure;

FIGS. 2A and 2B are side cross sections of an example of an anode electrode before and after aging/prelithiation, respectively, according to the present disclosure;

FIG. 3 is a functional block diagram of an example of a roll process for forming the anode active material layer of FIGS. 2A and 2B;

FIGS. 4A and 4B are side cross sections of another example of an anode electrode before and after aging/prelithiation, respectively, according to the present disclosure;

FIG. 5 is a functional block diagram of another example of a roll process for forming the anode active material layer of FIGS. 4A and 4B;

FIGS. 6A and 6B are side cross sections of another example of an anode electrode before and after aging/prelithiation, respectively, according to the present disclosure;

FIG. 7 is a functional block diagram of another example of a roll process for forming the anode active material layer of FIGS. 6A and 6B;

FIG. 8 illustrates a molecular structure of aluminum foil and annealed and prelithiated aluminum foil according to the present disclosure;

FIGS. 9A and 9B illustrate example of grain boundary distributions (>15°) for aluminum foil and annealed aluminum foil, respectively;

FIG. 10 illustrates an example of lithium ion diffusion paths within LiAl alloy according to the present disclosure;

FIG. 11 are examples of energy dispersive spectroscopy elemental mappings for double sided prelithiated aluminum foil and double sided annealed and prelithiated aluminum foil according to the present disclosure; and

FIG. 12 illustrates examples of x-ray diffusion patterns for aluminum foil, prelithiated aluminum foil, aluminum foil after annealing, and prelithiated aluminum foil after annealing.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Aluminum has attracted attention as an anode active material for high-energy-density all-solid-state batteries (ASSB). Aluminum is abundant and low cost and has a suitable operating potential (˜0.3 V vs Li+/Li). Aluminum has a theoretical capacity of 990 mAh/g (from Al (α phase, fcc) to LiAl (β phase, cubic) and a volume change of 96%, which is lower than the 310% volume change of silicon anode electrodes. However, even after prelithiation, aluminum has poor initial Coulombic efficiency and capacity delivery, which may be due to diffusional trapping of active lithium and mechanical fracture.

The present disclosure relates to aluminum anode electrodes for battery cells such as ASSBs. According to the present disclosure, aluminum foil is rolled and annealed to refine the aluminum grains and increase the sharpness of grain boundaries (GB). The annealed aluminum foil is subjected to a pretreatment process (prelithiation). During the prelithiation process, the use of annealed aluminum foil effectively increases the GB distribution and facilitates lithium-ion diffusion within the anode electrode. The pretreatment triggers spontaneous transformation from a phase (aluminum structure) to the β phase (LiAl), which compensates for active lithium loss to enhance the cell cycling.

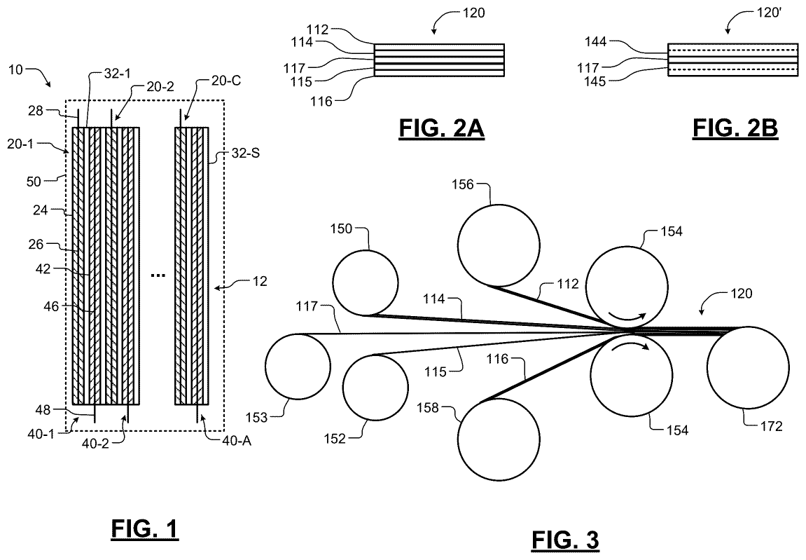

Referring now to FIG. 1, a battery cell 10 includes C cathode electrodes 20, A anode electrodes 40, and S separators 32 arranged in a predetermined sequence in a battery cell stack 12, where C, S and A are integers greater than zero. In some examples, the battery cell is an all-solid-state battery cell. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include an anode active material layer 42 and an anode current collector 46.

During charging/discharging, the A anode electrodes 40 and the C cathode electrodes 20 exchange lithium ions. In some examples, the cathode active material layers 24 comprise coatings including one or more active materials, one or more optional conductive additives, and/or one or more optional binder materials that are applied to the current collectors. In some examples, the S separators comprise solid electrolyte or a separator layer such as a polymer layer.

In some examples, the cathode current collector 26 comprises metal foil, metal mesh, perforated metal, 3 dimensional (3D) metal foam, and/or expanded metal. In some examples, the current collectors are made of one or more materials selected from a group consisting of stainless steel, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2A to 3, an example of an anode electrode 120 according to the present disclosure is shown during processing. The anode electrode 120 includes aluminum foil layers 112 and 116 that are rolled (pressed and/or heated) multiple times using one or sets of rollers and annealed prior to being mechanically bonded with lithium metal foil layers 114 and 115 and an anode current collector 117.

The aluminum foil layers 112 and 116 are rolled one or more times to ensure precise control of foil thickness and shape. In some examples, a thickness of aluminum foil after rolling is in a range from 2 μm to 80 μm. In some examples, a thickness of aluminum foil after rolling is in a range from 30 μm to 50 μm (e.g., 40 μm). In some examples, the aluminum foil layers 112 and 116 comprise 94.0 wt % to 99.99 wt % of aluminum. In some examples, the aluminum foil layers 112 and 116 comprise 98.0 wt % to 99.95 wt % of aluminum (e.g., 99 wt %).

After rolling, the aluminum foil layers 112 and 116 are annealed. During annealing, recrystallization and polygonization are initiated to refine the grains and increase the sharpness of the grain boundaries. In some examples, annealing is performed at a temperature in a range from 250° C. to 550° C. In some examples, annealing is performed at a temperature in a range from 300° C. to 400° C. (e.g., 350° C.). In some examples, the annealing period is in a range from 10 minutes to 24hours. In some examples, the annealing period is in a range from 30 minutes to 90 minutes (e.g., 60 minutes).

In some examples, the grain boundary distribution (>15°) after annealing is in a range from 46% to 80%. In some examples, the grain boundary distribution (>15°) after annealing is in a range from 60% to 70% (e.g., 65%).

After rolling and annealing, the aluminum foil layers 112 and 116 are mechanically bonded with lithium metal foil layers 114 and 115 arranged on opposite sides of an anode current collector 117 such as a copper layer.

In FIG. 2B, the anode electrode 120 is shown after aging as the anode electrode 120′. The aluminum foil layers 112 and 116 and the lithium metal foil layer 114 are aged for a predetermined period to allow prelithiation to occur. After aging, the anode electrode 120′ includes dual layers 144 and 145 each including an outer aluminum layer and an inner lithium aluminum layer.

In FIG. 3, rolls 150 and 152 including the lithium metal foil layers 114 and 115 are supplied between a pair of rollers 154. A roll 153 supplies the anode current collector 117 between the pair of rollers 154. Rolls 156 and 158 supply annealed aluminum foil layers 112 and 116 between the pair of rollers 154. The pair of rollers 154 mechanically bond the layers to form an anode electrode 120 that is collected onto roll 172. The rolling process is followed by an aging process to allow spontaneous prelithiation and formation of the lithium aluminum layer 144.

In some examples, the thickness of lithium metal foil layer 114 is in a range from 2 μm to 50 μm. In some examples, the thickness of lithium metal foil layer 114 is in a range from 10 μm to 30 μm (e.g., 20 μm). In some examples, the prelithiation period is in a range from 1 minute to 14 days. In some examples, the prelithiation period is in a range from 6 hours to 10 hours (e.g., 8 hours).

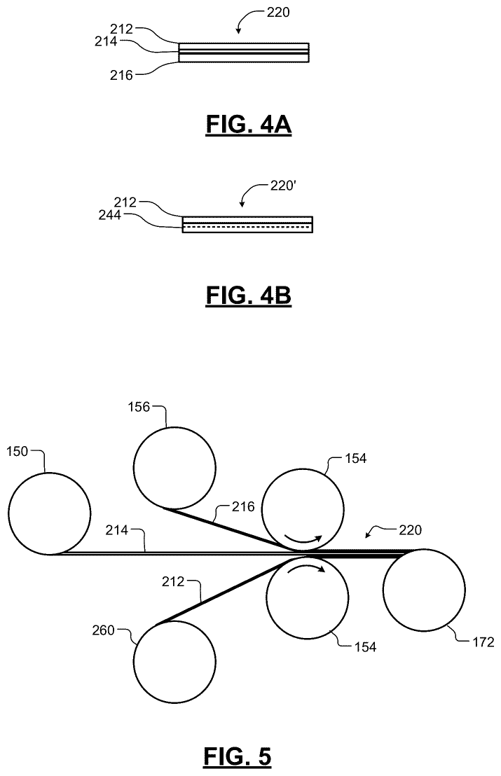

Referring now to FIGS. 4A to 5, an anode electrode 220 is shown. In FIG. 4A, the anode electrode 220 is shown prior to aging/prelithiation. The anode electrode 220 includes a separator layer 212, a lithium metal foil layer 214, and an annealed aluminum foil layer 216 that are mechanically bonded. In some examples, the separator layer 212 comprises a polymer layer. In some examples, the polymer layer comprises a polyethylene terephthalate (PET) membrane although other materials can be used.

In FIG. 4B, the anode electrode 220 is shown as anode electrode 220′ after aging for a predetermined period to allow prelithiation to occur. After aging, the anode electrode 220′ includes a dual layer 190 including an annealed aluminum layer-lithium aluminum (LiAl) layer arranged adjacent to the separator layer 212. In this example, the annealed aluminum foil layer may include a terminal acting as the anode current collector connection.

In FIG. 5, a roll 150 including the lithium metal foil layer 214 is supplied between a pair of rollers 154. The roll 156 supplies the annealed aluminum foil layer 216 between the pair of rollers 154. A roll 260 supplies the separator layer 212 between the pair of rollers 154. The pair of rollers 154 apply pressure and/or heat to mechanically bond the layers of the anode electrode 220, which is collected onto the roll 172 and allowed to age to allow prelithiation to occur as described above.

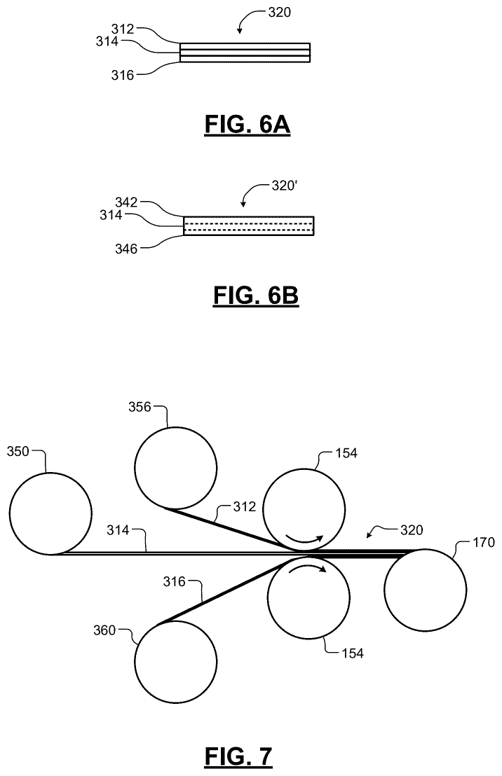

Referring now to FIGS. 6A to 7, an anode electrode 320 is shown. In FIG. 8A, the anode electrode 320 is shown after pressing and prior to aging/prelithiation. The anode electrode 320 includes lithium metal foil layers 312 and 316 arranged on opposite sides of an annealed aluminum foil layer 314.

In FIG. 6B, the anode electrode 320 is shown as an anode electrode 320′ after aging. The anode electrode 320′ includes two dual layers 342 and 346 (each including lithium aluminum (LiAl)-annealed aluminum) on opposite sides of the annealed aluminum foil layer 314. In this example, the annealed aluminum foil layer may include a terminal acting as the anode current collector connection.

In FIG. 7, a roll 350 including the annealed aluminum foil layer 314 is supplied between a pair of rollers 154. Rolls 356 and 360 supply lithium metal foil layers 312 and 316 between the pair of rollers 154. The pair of rollers 154 apply pressure and/or heat to mechanically bond layers of the anode electrode 320, which is collected onto roll 172 and allowed to age to allow prelithiation to occur as described above.

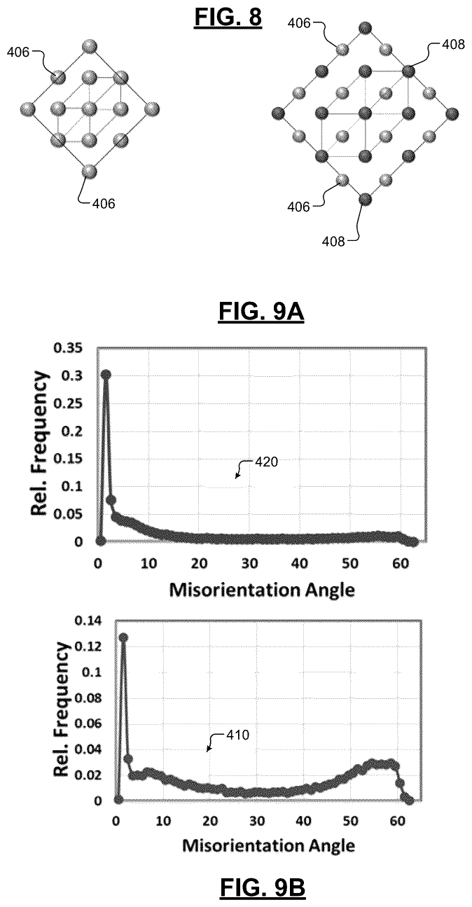

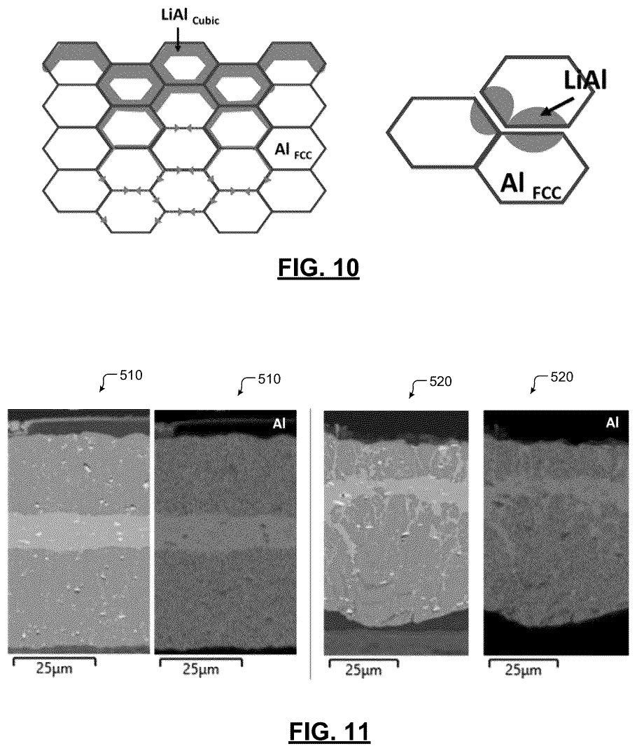

Referring now to FIGS. 8 to 9B, the prelithiation step triggers spontaneous transformation from a phase (Al structure, Face-centered Cubic, fcc) to the β phase (LiAl, cubic), where the formed LiAl compensates for active lithium loss to enhance cell cycling (aluminum atoms 406, lithium atoms 408 in FIG. 8). In FIGS. 9A and 9B, aluminum foil is shown before (at 420) and after annealing (at 410). As can be seen, annealing tunes the grain boundary distribution.

Referring now to FIGS. 10 and 11, grain boundary diffusion is the fastest diffusion path. Phase transition alters the grain boundary (GB) complexion, when the Al—Al GBs change to LiAl—Al or LiAl—LiAl GBs (with violent GB sliding). The GB free volume increases in situ so that the Li diffusion ability along the GBs is enhanced for future Li invasion. In contrast, for Li atom diffusion in LiAl/AI phase boundaries (PBs), the interface does not change much because the PBs move vertically and PB interface is relatively invariant (maintaining a relatively low diffusion ability). GB diffusion is the fastest diffusion path as compared to other paths (phase boundaries, dislocation cores, or lattice). The annealing of Al foil clearly increases the GB distribution, which greatly facilitates lithium-ion diffusion.

In FIG. 11, an anode active material layer 510 including a double-sided prelithiated aluminum foil and an anode active material layer 520 including a double-sided annealed and prelithiated aluminum foil are shown after the same prelithiation period (7 days). The anode active material layer 520 including the double-sided annealed and prelithiated aluminum foil generates more Li—Al, which indicates faster lithium-ion diffusion.

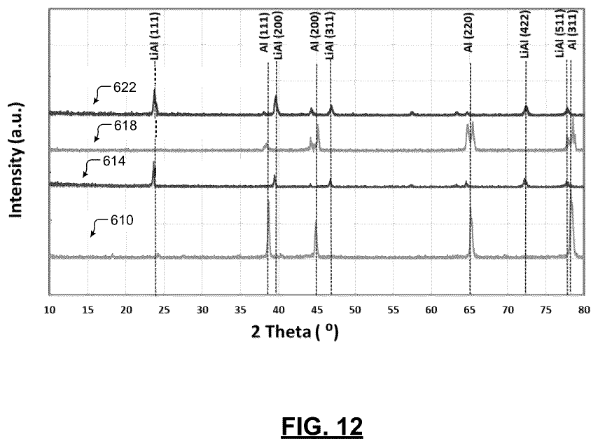

Referring now to FIG. 12, an X-ray diffraction pattern is shown for aluminum foil at 610, prelithiated aluminum foil at 614, aluminum foil after annealing at 618, and prelithiated aluminum foil after annealing at 622. The peaks of the prelithiated aluminum foil and aluminum foil after annealing are in good agreement with standard data of LiAl crystal in the inorganic crystal structure database (ICSD).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing an anode electrode, comprising:
rolling a first aluminum foil layer;
annealing the first aluminum foil layer to create a first annealed aluminum foil layer;
mechanically bonding a first lithium metal foil layer between an anode current collector and the first annealed aluminum foil layer; and
aging the anode electrode to prelithiate the first annealed aluminum foil layer.

2. The method of claim 1, wherein a thickness of the first annealed aluminum foil layer is in a range from 2 μm to 80 μm.

3. The method of claim 1, wherein a thickness of the first annealed aluminum foil layer is in a range from 30 μm to 50 μm.

4. The method of claim 1, wherein the first annealed aluminum foil layer comprise aluminum in a range from 94.0 to 99.99 wt %.

5. The method of claim 1, wherein the annealing of the first annealed aluminum foil layer is performed at a temperature in a range from 250° C. to 550° C.

6. The method of claim 1, wherein an annealing period of the first annealed aluminum foil layer is in a range from 10 minutes to 24 hours.

7. The method of claim 1, wherein a grain boundary distribution (>15°) of the first annealed aluminum foil layer after annealing is in a range from 46% to 80%.

8. The method of claim 1, wherein a prelithiation period is in a range from 1 minute to 14 days.

9. The method of claim 1, further comprising:
prior to the mechanically bonding, arranging a second lithium metal foil layer adjacent to an opposite side of the anode current collector and a second annealed aluminum foil layer adjacent to the second lithium metal foil layer,
wherein the mechanically bonding further comprises mechanically bonding the first annealed aluminum foil layer, the first lithium metal foil layer, the anode current collector, the second lithium metal foil layer, and the second annealed aluminum foil layer, and
wherein the aging further prelithiates the second annealed aluminum foil layer.

10. A method for manufacturing an anode electrode, comprising:
rolling an aluminum foil layer;
annealing the aluminum foil layer to form an annealed aluminum foil layer;
mechanically bonding a separator layer and the annealed aluminum foil layer to opposite sides of a lithium metal foil layer; and
aging the anode electrode to prelithiate the annealed aluminum foil layer.

11. The method of claim 10, wherein the separator layer comprises a polymer layer.

12. The method of claim 10, wherein a thickness of the annealed aluminum foil layer is in a range from 2 μm to 80 μm.

13. The method of claim 10, wherein a thickness of the annealed aluminum foil layer is in a range from 30 μm to 50 μm.

14. The method of claim 10, wherein the annealed aluminum foil layer comprise aluminum in a range from 94.0 to 99.99 wt %.

15. The method of claim 10, wherein the annealing of the annealed aluminum foil layer is performed at a temperature in a range from 250° C. to 550° C.

16. The method of claim 10, wherein an annealing period of the annealed aluminum foil layer is in a range from 10 minutes to 24 hours.

17. The method of claim 10, wherein a grain boundary distribution (>15°) of the annealed aluminum foil layer is in a range from 46% to 80%.

18. A method for manufacturing an anode electrode, comprising:
rolling an aluminum foil layer;
annealing the aluminum foil layer to form an annealed aluminum foil layer;
mechanically bonding a first lithium metal foil layer and a second lithium metal foil layer to opposite sides of the annealed aluminum foil layer; and
aging the anode electrode to prelithiate the annealed aluminum foil layer.

19. The method of claim 18, wherein:
annealing of the annealed aluminum foil layer is performed at a temperature in a range from 250° C. to 550° C., and an annealing period of the annealed aluminum foil layer is in a range from 10 minutes to 24 hours.

20. The method of claim 18, wherein:
a thickness of the annealed aluminum foil layer is in a range from 2 μm to 80 μm,
the annealed aluminum foil layer comprises aluminum in a range from 94.0 to 99.99 wt %, and
a grain boundary distribution (>15°) of the annealed aluminum foil layer is in a range from 46% to 80%.
